(19) United States
(12) Patent Application Publication
(10) Pub. No.: US 2026/0276186 A1
(43) Pub. Date: Sep. 17, 2026

(54) Support stand and lighting device

(71) Applicant: Shenzhen Habitat Technology Co., Ltd, Shenzhen (CN)

(72) Inventors: Jing CHEN, Shenzhen (CN); Yong CHEN, Shenzhen (CN)

(73) Assignee: Shenzhen Habitat Technology Co., Ltd, Shenzhen (CN)

(21) Appl. No.: 19/558,519

(22) Filed: Mar. 6, 2026

Related U.S. Application Data
(63) Continuation of application No. PCT/CN2025/111444, filed on Jul. 30, 2025.

(30) Foreign Application Priority Data
Mar. 14, 2025 (CN) 202520461514.0

(51) Int. Cl. F21V 21/096; F21V 15/01; F21V 21/26; F21V 21/30; F21V 21/22

(52) U.S. Cl. CPC F21V 21/096; F21V 15/01; F21V 21/26; F21V 21/30; F21V 21/22

(57) ABSTRACT

The provided is a support stand and a lighting device. The support stand includes a main body, a plurality of support legs, and a magnetic footpad assembly, where a first end of each support leg is rotatably connected to the main body; the plurality of support legs rotate relative to the main body for unfolding and folding; a second end of at least one of the support legs is provided with the magnetic footpad assembly; the magnetic footpad assembly includes a protective shell and a magnet; the magnet is disposed in the protective shell; and an angle of the magnet relative to the support leg is adjustable. When the support stand is used on the uneven ground, tabletop or wall surface, since the magnetic footpad assembly can freely adjust a magnetic attraction angle, the magnetic footpad assembly is closely attached to a target object to ensure the magnetic attraction force.

### CROSS REFERENCE TO THE RELATED APPLICATIONS

This application is a continuation application of International Application No. PCT/CN2025/111444, filed on Jul. 30, 2025, which is based upon and claims priority to Chinese Patent Application No. 202520461514.0, filed on Mar. 14, 2025, the entire contents of which are incorporated herein by reference.

### TECHNICAL FIELD

The present disclosure relates to the technical field of support devices, and in particular, to a support stand and a lighting device.

### BACKGROUND

Existing support stands have been widely used because a plurality of support legs can be quickly switched from a folded state to an unfolded state. However, it is often inconvenient to adjust the height of each support leg. Thus, when the stands are used on uneven ground, tabletops or wall surfaces, they have difficulty maintaining balance and prone to wobbling, resulting in poor stability.

### SUMMARY

In view of this, it is necessary to provide a support stand with high stability and a lighting device.

According to a first aspect, the present disclosure provides a support stand, including:

a main body;

a plurality of support legs, where a first end of each of the support legs is rotatably connected to the main body, and the plurality of support legs rotate relative to the main body for unfolding and folding; and

a magnetic footpad assembly, where a second end of at least one of the support legs is provided with the magnetic footpad assembly, the magnetic footpad assembly includes a protective shell and a magnet, the magnet is disposed in the protective shell, and an angle of the magnet relative to the support leg is adjustable.

According to a second aspect, the present disclosure provides a lighting device, including: a lighting assembly and the above support stand, where the lighting assembly is disposed on a top end of the main body.

The present disclosure has at least the following beneficial effects:

According to the support stand, the support legs can rotate away from the main body for unfolding, which increases radii of ground support points, thereby effectively enhancing the standing stability of the support stand, and ensuring that the support stand can stand stably even when tilted. Additionally, the support legs can rotate close to the main body for folding. In a folded state, the support stand is more compact, and easy to carry.

In addition, in this solution, the second end of at least one support leg is provided with the magnetic footpad assembly, the magnetic footpad assembly includes the protective shell and the magnet, the magnet is disposed in the protective shell, and the angle of the magnet relative to the support leg is adjustable. In this way, when the support stand is used on the uneven ground, tabletop or wall surface, since the magnet can freely adjust a magnetic attraction angle, the magnet is closely attached to a target object to ensure the magnetic attraction force, thereby reinforcing the support stand and enhancing the stability of the support stand. Meanwhile, a height of the support leg changes with the angle of the magnet. By adjusting the height of at least one support leg, the support stand is more stable, thereby preventing the support stand from wobbling. In addition, by disposing the magnet in the protective shell, the magnet is not directly exposed to the air, thereby preventing corrosion by the ambient environment, and prolonging the service life of the magnet.

### BRIEF DESCRIPTION OF THE DRAWINGS

In order to illustrate the technical solutions of the embodiments of the present disclosure or of the prior art more clearly, the following drawings are briefly described as required in the context of the embodiments or the prior art. Obviously, the following drawings illustrate only some of the embodiments of the present disclosure. Other relevant drawings may be obtained on the basis of the shown structures of these drawings without any creative effort by those skilled in the art.

FIG. 1 is a schematic structural view of a lighting device according to an embodiment;

FIG. 2 is an enlarged view of A shown in FIG. 1;

FIG. 3 is a sectional view of a magnetic footpad assembly according to an embodiment;

FIG. 4 is a schematic structural view of a lighting device from another viewing angle according to an embodiment;

FIG. 5 is a schematic exploded view of a lighting assembly according to an embodiment; and

FIG. 6 is a partial schematic structural view of a lighting assembly according to an embodiment.

### REFERENCE NUMERALS

10: lighting device, 100: lighting assembly, 200: support stand, 110: light-emitting assembly, 120: connector, 121: gap, 122: second connecting portion, 123: first connecting portion, 130: radiator, 131: avoidance notch, 132: heat dissipation body, 133: heat dissipation cover, 134: rotating cavity, 140: light-emitting member, 210: main body, 220: sliding member, 230: support leg, 240: support rod, 250: magnetic footpad assembly, 251: protective shell, 252: magnet, 2521: magnetic attraction surface, 253: rotation shaft, 254: avoidance opening, 255: first fixing hole, 256: second fixing hole, 257: fastener, 260: telescopic member, 262: fixed end, and 264: free end.

### DETAILED DESCRIPTION OF THE EMBODIMENTS

Typical embodiments reflecting features and advantages of the present disclosure will be described in detail in the following description. It should be understood that the present disclosure may admit to various modifications in different embodiments without departing from the scope of the present disclosure. The descriptions and drawings therein are substantially illustrative in nature rather than restrictive of the present disclosure.

Furthermore, the related terms “first”, and “second” are used for descriptive purposes only and are not to be understood as indicating or implying relative importance or implicitly specifying the number of technical features indicated. Thus, features defined as “first” or “second” may explicitly or implicitly include one or more of such features. In the description of the present application, the term “a plurality of” means two or more unless otherwise expressly specified.

In the description of the present application, it should be noted that terms such as “installed,”“provided,” and “connected” should be broadly understood unless otherwise expressly defined and limited. For example, a connection may be a fixed connection, a detachable connection, or an integral connection; may be a mechanical connection or an electrical connection; may be a direct connection or an indirect connection through an intermediate medium; and may be communication between interiors of two components. Those of ordinary skill in the art may understand the specific meanings of the above terms in the present disclosure based on practical contexts.

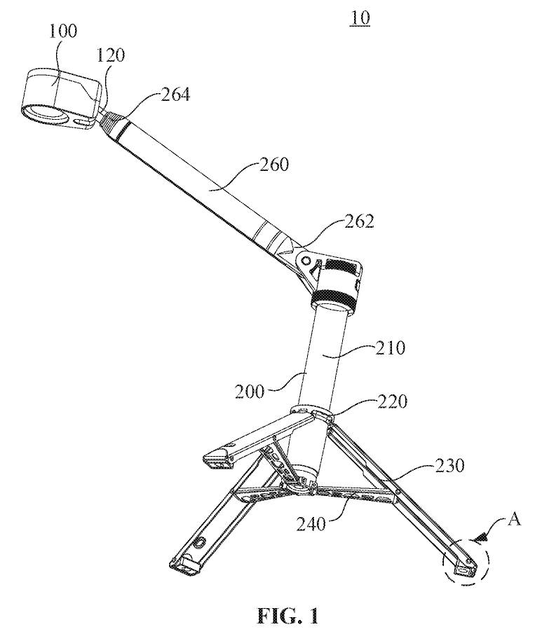

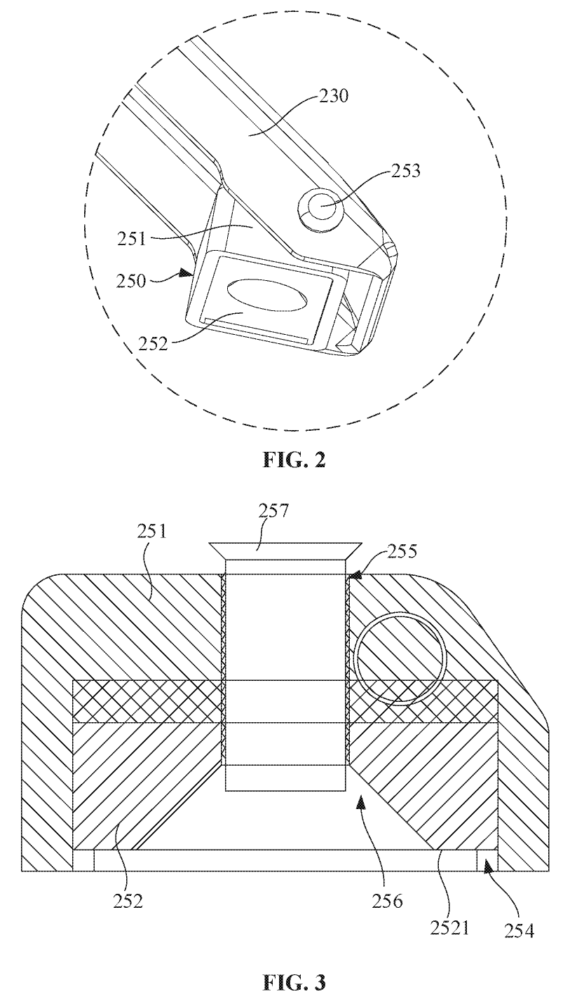

As shown in FIGS. 1 and 2, the present disclosure provides support stand 200. The support stand 200 may be placed on the ground or attached to a target object (such as a metal object). The support stand 200 may also be attached to elevated surfaces such as a metal ceiling to enable various application scenarios, and is not limited thereto.

The support stand 200 includes main body 210, a plurality of support legs 230, and magnetic footpad assembly 250. A top end of the main body 210 may be configured to mount a load device. The load device may be, but is not limited to, lighting assembly 100. First ends of the support legs 230 are rotatably connected to the main body 210. The support legs 230 rotate relative to the main body 210 for unfolding and folding. A second end of at least one of the support legs 230 is provided with the magnetic footpad assembly 250. The magnetic footpad assembly 250 includes protective shell 251 and magnet 252. The magnet 252 is disposed in the protective shell 251. An angle of the magnet 252 relative to the support leg 230 is adjustable.

According to the support stand 200, the support legs 230 can rotate away from the main body 210 for unfolding, which increases radii of ground support points, thereby effectively enhancing the standing stability of the support stand 200, and ensuring that the support stand 200 can stand stably even when tilted. Additionally, the support legs 230 can rotate close to the main body 210 for folding. In a folded state, the support stand 200 is more compact, and easy to carry.

In addition, in this solution, the second end of at least one support leg 230 is provided with the magnetic footpad assembly 250, the magnetic footpad assembly 250 includes the protective shell 251 and the magnet 252, the magnet 252 is disposed in the protective shell 251, and the angle of the magnet 252 relative to the support leg 230 is adjustable. When the support stand 200 is used on the uneven ground, tabletop or wall surface, since the magnet 252 can freely adjust a magnetic attraction angle, the magnet 252 is closely attached to the target object to ensure the magnetic attraction force, thereby reinforcing the support stand 200 and enhancing the stability of the support stand 200. Meanwhile, a height of the support leg 230 changes with the angle of the magnet 252. By adjusting the height of at least one support leg 230, the support stand 200 is more stable, thereby preventing the support stand 200 from wobbling. In addition, by disposing the magnet 252 in the protective shell 251, the magnet 252 is not directly exposed to the air, thereby preventing corrosion by the ambient environment, and prolonging the service life of the magnet 252.

As shown in FIG. 1, specifically, second ends of the support legs 230 each are provided with the magnetic footpad assembly 250. In this way, by adjusting heights of the support legs 230, the support stand 200 can be more stable, thereby preventing the support stand 200 from wobbling.

Although three support legs are shown in the figure, there are two support legs in other embodiments. In this case, when the two support legs 230 are in the folded state, magnets 252 disposed on second ends of the two support legs 230 can attract each other, so as to maintain the two support legs 230 in the folded state.

As shown in FIGS. 2 and 3, in an embodiment, the protective shell 251 encloses a periphery and a top surface of the magnet 252. A bottom of the protective shell 251 is provided with avoidance opening 254. A bottom surface of the magnet 252 is exposed through the avoidance opening 254. The bottom surface of the magnet 252 constitutes magnetic attraction surface 2521 of the magnet 252, such that the magnet 252 is closely attached to the target object to ensure the magnetic attraction force. The bottom surface of the magnet 252 is higher than the bottom surface of the protective shell 251, i.e., the magnet 252 is entirely disposed in the protective shell 251. It is to be understood that in other embodiments, the magnet 252 may be partially exposed out of the protective shell 251.

As shown in FIG. 3, in an embodiment, the protective shell 251 is provided with first fixing hole 255. The magnet 252 is provided with second fixing hole 256. The magnetic footpad assembly 250 further includes fastener 257. The fastener 257 passes through the first fixing hole 255 and the second fixing hole 256 in sequence, so as to fixedly connect the protective shell 251 and the magnet 252. Specifically, the first fixing hole 255 is formed in a center of a top of the protective shell 251, and penetrates through the top of the protective shell 251. The second fixing hole 256 is formed in a middle of the magnet 252. The second fixing hole 256 extends along a thickness direction of the magnet 252, and penetrates through a bottom and a top of the magnet 252. The first fixing hole 255 is coaxial with the second fixing hole 256. The fastener 257 may be, but is not limited to, a threaded fastener.

In an embodiment, the magnet 252 and the protective shell 251 each have a rectangular cross-section. An outer contour of the magnet 252 matches an inner contour of the protective shell 251, such that the protective shell 251 is closely attached to the magnet 252.

As shown in FIG. 2, optionally, the protective shell 251 is rotatably disposed on the second end of the support leg 230. The protective shell 251 enables the angle of the magnet 252 relative to the support leg 230 to be adjusted, i.e., through rotation of the protective shell 251, the magnet 252 is driven to rotate, thereby adjusting the angle of the magnet 252. The magnetic footpad assembly 250 further includes rotation shaft 253. The rotation shaft 253 is connected to the protective shell 251 and the second end of the support leg 230. The protective shell 251 can rotate axially about the rotation shaft 253 relative to the support leg 230. In an embodiment, a first connecting hole is formed in a side wall of the protective shell 251. The second end of the support leg 230 is provided with a second connecting hole. The rotation shaft 253 penetrates into the first connecting hole and the second connecting hole, such that the protective shell 251 can rotate axially about the rotation shaft 253 relative to the support leg 230. It is to be understood that in other embodiments, the first connecting hole may be omitted. In this case, the rotation shaft 253 may be fixedly connected to the protective shell 251, and penetrates into the second connecting hole. Alternatively, the second connecting hole may be omitted. In this case, the rotation shaft 253 may be fixedly connected to the second end of the support leg 230, and penetrates into the first connecting hole.

Optionally, the protective shell 251 is a flexible housing. With flexible deformation, the protective shell 251 enables the angle of the magnet 252 relative to the support leg 230 to be adjusted. In this way, the protective shell 251 is rotatably connected to the support leg 230 without the aid of the rotation shaft 253, and the magnet 252 can also freely adjust the angle under the action of the flexible deformation of the flexible housing.

Optionally, the magnet 252 may be a strong magnet. The target object may also be a substance attachable to the magnet, such as iron, cobalt, nickel, and their alloys.

Specifically in this embodiment, there may be three support legs 230. When the three support legs 230 are in an unfolded state, the three support legs 230 form a triangular structure, such that the support stand 200 achieves high stability and strength. It is to be understood that in other embodiments, there may be two or four or more support legs 230, which is not limited herein.

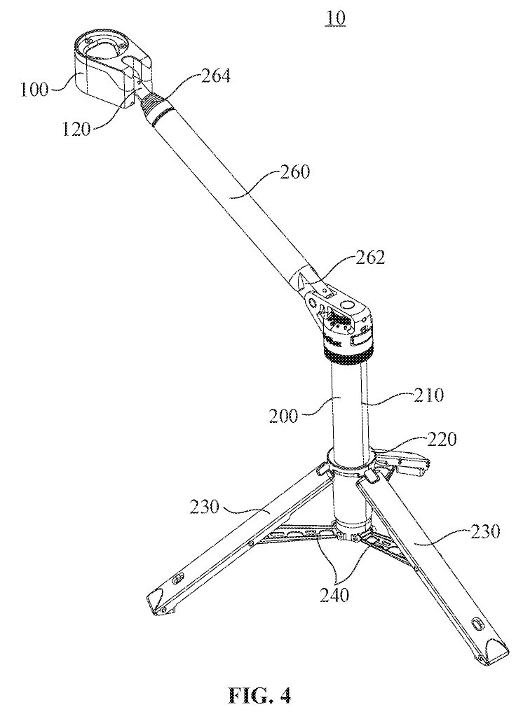

As shown in FIGS. 1 and 4, further, in order to enhance convenience for unfolding and folding the support legs 230, the support stand 200 further includes sliding member 220. The sliding member 220 is slidably sleeved on an outer side of the main body 210. A first end of each support leg 230 is rotatably connected to the sliding member 220. When the support legs 230 move along an axial direction of the main body 210 with the sliding member 220 and toward a bottom end of the main body 210, the support legs 230 can rotate away from the main body 210 and are unfolded. When the support legs 230 move along the axial direction of the main body 210 with the sliding member 220 and toward the top end of the main body 210, the support legs 230 can rotate close to the main body 210 and are folded.

According to the support stand 200, when the support legs 230 move along the axial direction of the main body 210 with the sliding member 220 and toward the bottom end of the main body 210, the support legs 230 can rotate away from the main body 210 and are unfolded. This increases the radii of the ground support points, thereby effectively enhancing the standing stability of the support stand 200, and ensuring that the support stand 200 can stand stably even when tilted. Additionally, when the support legs 230 move along the axial direction of the main body 210 with the sliding member 220 and toward the top end of the main body 210, the support legs 230 can rotate close to the main body 210 and are folded. By moving the sliding member 220, the support legs 230 are unfolded and folded. In the folded state, the support stand 200 is more compact, and easy to carry. It is to be noted that the case where the support legs 230 are unfolded and folded by moving the sliding member 220 is merely an implementation, and is not limited herein.

As shown in FIGS. 1 and 4, further, the support stand 200 further includes a plurality of support rods 240. A first end of each support rod 240 is rotatably connected to a middle of the support leg 230. A second end of each support rod 240 is rotatably connected to the bottom end of the main body 210. The support rods 240 are in one-to-one correspondence with the support legs 230. By providing the support rod 240, the sliding member 220 and the support leg 230 form a triangular structure with the support rod 240, achieving high stability and strength.

As shown in FIGS. 1 and 4, further, the support stand 200 further includes telescopic member 260. The telescopic member 260 has fixed end 262 and free end 264 that are opposite to each other along an axial direction of the telescopic member 260. The fixed end 262 of the telescopic member 260 is connected to the top end of the main body 210. The free end 264 of the telescopic member 260 can move close to and away from the main body 210 relative to the fixed end 262 of the telescopic member 260.

During specific use, the telescopic member 260 can be appropriately lengthened according to different application scenarios, so as to heighten the support stand 200. When the support stand 200 is stored, the telescopic member 260 can be retracted. Therefore, according to the support stand 200, with the telescopic member 260, the height of the support stand 200 can be adjusted within a wide range, expanding the application range of the support stand 200 and facilitating portability.

The free end 264 of the telescopic member 260 is an end that can be extended or retracted. The fixed end 262 of the telescopic member 260 is an end for fixing the telescopic member 260. When the telescopic member 260 is in a stored state, the free end 264 of the telescopic member 260 is received in the fixed end 262 of the telescopic member 260. After the free end 264 of the telescopic member 260 is pulled out from the fixed end 262 of the telescopic member 260, the telescopic member 260 is in an extended state. Certainly, in this embodiment, the telescopic member 260 further has a fully extended or partially extended state, which can be specifically set according to an actual application scenario of the support stand 200, and is not limited herein.

Specifically, the load device (such as the lighting assembly 100) is configured to be disposed on the free end 264 of the telescopic member 260. In this case, the load device can move away from the fixed end 262 of the telescopic member 260 as the free end 264 of the telescopic member 260 is extended, i.e., the load device is heightened. Alternatively, the load device can move close to the fixed end 262 of the telescopic member 260 as the free end 264 of the telescopic member 260 is retracted, i.e., the load device is lowered. The telescopic member 260 can be adapted to application scenarios of different heights, and the telescopic member 260 can also be appropriately lengthened according to different application scenarios. When the load device and the support stand 200 are stored, the telescopic member 260 can be retracted, such that the load device can be stored together with other structures of the support stand 200. This reduces the occupied space, and is easy to carry.

Further, the fixed end 262 of the telescopic member 260 is rotatably connected to the top end of the main body 210. In this case, the fixed end 262 of the telescopic member 260 can rotate relative to the main body 210. For the support stand 200, through rotation of the fixed end 262 of the telescopic member 260, an angle of the telescopic member 260 can be adjusted, expanding the application range of the support stand 200 and facilitating portability.

Specifically, while the height of the load device (such as the lighting assembly 100) is adjusted through the telescopic member 260, the angle of the load device can further be adjusted through the rotation of the fixed end 262 of the telescopic member 260 relative to the main body 210, so as to achieve a wider range of angular adjustment for the load device, thereby enhancing the user experience.

Further, in order to achieve extension and retraction of the telescopic member 260, the telescopic member 260 includes a plurality of telescopic rods that are sleeved in sequence. Inner diameters of the telescopic rods gradually decrease in sequence from the fixed end 262 of the telescopic member 260 to the free end 264 of the telescopic member 260. That is, when the telescopic member 260 is in the extended state, the inner diameters of the telescopic rods gradually decrease in a direction from an end of the telescopic member 260 close to the main body 210 to an end of the telescopic member 260 away from the main body 210. In other words, a telescopic rod closest to the main body 210 has a maximum inner diameter, such that other telescopic rods can be stored to the telescopic rod with the maximum inner diameter.

Optionally, the telescopic rods are made of aluminum. Alternatively, the telescopic rods may also be made of other materials, such as an aluminum alloy, copper, iron, or a composite material, which is not limited herein.

As shown in FIGS. 1 and 4, the present disclosure further provides lighting device 10. The lighting device 10 includes the lighting assembly 100 and the above support stand 200. The lighting assembly 100 is disposed on the top end of the main body 210. Optionally, the lighting assembly 100 is rotatably disposed on the top end of the main body 210, so as to adjust a light-emitting angle of the lighting assembly 100. This ensures that the light-emitting angle of the lighting assembly 100 can be calibrated within a certain range.

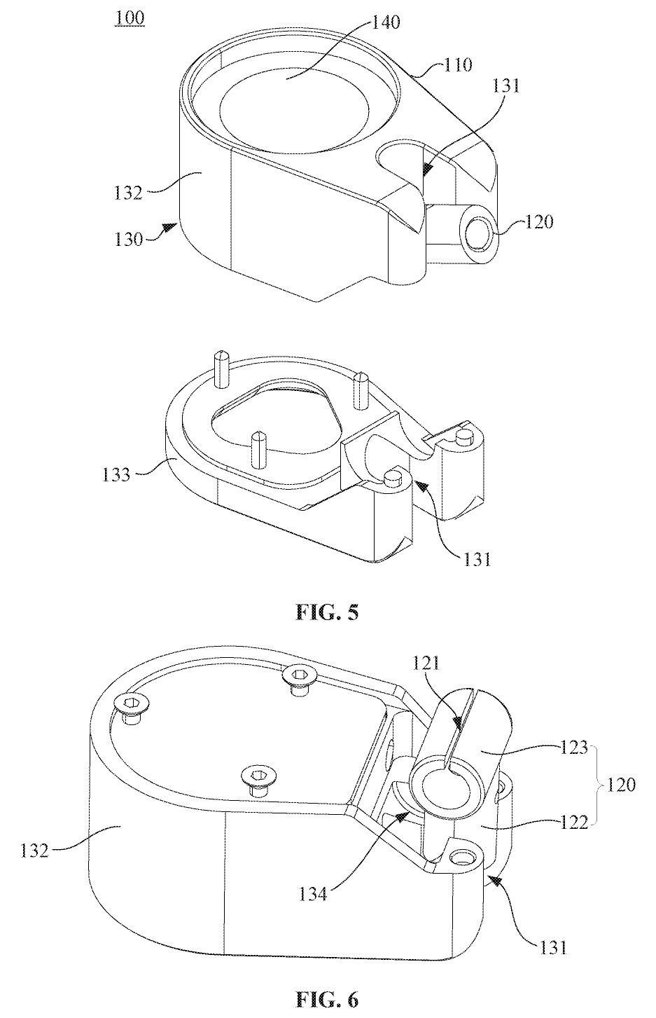

As shown in FIGS. 5 and 6, the lighting assembly 100 includes light-emitting assembly 110 and connector 120. The light-emitting assembly 110 is provided with rotating cavity 134. The connector 120 includes first connecting portion 123 and second connecting portion 122. The first connecting portion 123 is rotatably connected into the rotating cavity 134, so as to adjust the light-emitting angle of the lighting assembly 110 relative to the connector 120. The first connecting portion 123 is provided with gap 121. The first connecting portion 123 is squeezed into the rotating cavity 134. The gap 121 is configured for the connector 120 to deform to generate an elastic force when squeezed. The second connecting portion 122 is connected to the first connecting portion 123. The second connecting portion 122 is connected to the support stand 200. Specifically, the second connecting portion 122 is connected to the top end of the main body 210. More specifically, the second connecting portion 122 is inserted into the free end 264 of the telescopic member 260.

According to the lighting assembly 100 provided by the present disclosure, the light-emitting assembly 110 is provided with the rotating cavity 134. The connector 120 includes the first connecting portion 123 and the second connecting portion 122. The first connecting portion 123 is rotatably connected into the rotating cavity 134, so as to adjust the light-emitting angle of the light-emitting assembly 110 relative to the connector 120, thereby calibrating the light-emitting angle of the light-emitting assembly 110 within a certain range. In addition, in this solution, the first connecting portion 123 is squeezed into the rotating cavity 134, and the first connecting portion 123 is provided with the gap 121, such that the connector 120 deforms when squeezed by the light-emitting assembly 110. In this case, through a deformation space in the gap 121 of the connector 120, a size of the connector 120 changes with a pressure. Since the connector 120 provided with the gap 121 can deform under the pressure to generate the elastic force, and apply the elastic force to the light-emitting assembly 110, a frictional force between the connector 120 and the light-emitting assembly 110 increases during rotation of the light-emitting assembly 110. This ensures that the light-emitting assembly 110 neither wobbles due to being too loose nor fails to rotate due to being too tight during rotation, and maintains a balanced rotational resistance at all times. Meanwhile, with the gap 121, the service life of the connector 120 can further be prolonged.

As shown in FIG. 6, specifically, the first connecting portion 123 is shaft-shaped and extends to its two ends. The first connecting portion 123 is a hollow structure with two open ends. The gap 121 extends linearly. The gap 121 extends from a center of the first connecting portion 123 to edges of two axial ends of the first connecting portion 123. It is to be understood that in other embodiments, a shape of the first connecting portion 123 is not limited. For example, the first connecting portion 123 may further be spherical, provided that the gap 121 of the first connecting portion 123 can enable deformation of the first connecting portion 123 under the pressure.

Further, the second connecting portion 122 is shaft-shaped and extends to its two ends. The second connecting portion 122 is a hollow structure with two open ends. The first connecting portion 123 is perpendicularly connected to the second connecting portion 122. The first connecting portion 123 is combined with the second connecting portion 122 to form the T-shaped connector 120. The hollow structure of the first connecting portion 123 communicates with the hollow structure of the second connecting portion 122, such that an electrical lead can be connected to a circuit in the light-emitting assembly 110 through two hollow structures, thereby realizing power supply or control on the light-emitting assembly 110. The second connecting portion 122 may be integrally formed with the first connecting portion 123.

As shown in FIGS. 5 and 6, specifically, the rotating cavity 134 is formed inside the light-emitting assembly 110. The light-emitting assembly 110 is further provided with avoidance notch 131. The avoidance notch 131 extends from the rotating cavity 134 to an edge of the light-emitting assembly 110. The avoidance notch 131 is configured to provide a space through which the second connecting portion 122 movably penetrates into the avoidance notch 131, ensuring that the lighting assembly 100 is more structurally compact. Specifically, the first connecting portion 123 is partially accommodated in the rotating cavity 134. The avoidance notch 131 is configured to provide a space through which the second connecting portion 122 and the first connecting portion 123 located outside the rotating cavity 134 movably penetrate into the avoidance notch 131. More specifically, two ends of the first connecting portion 123 are accommodated in the rotating cavity 134, while a middle of the first connecting portion 123 is located in the avoidance notch 131. The avoidance notch 131 is configured to provide a moving space for the middle of the first connecting portion 123 and the second connecting portion 122. In other embodiments, the first connecting portion 123 may be entirely accommodated in the rotating cavity 134. In this case, the gap 121 extends from the center of the first connecting portion 123 to the edges of the two axial ends of the first connecting portion 123, so as to increase the elastic force to the greatest extent when the first connecting portion 123 is squeezed. It is to be noted that the second connecting portion 122 is less than the first connecting portion 123 in radial size or thickness, and the second connecting portion 122 should be connected to the first connecting portion 123 as centrally as possible. In this way, the second connecting portion 122 can swing in the avoidance notch 131 within a large angle range as much as possible. Otherwise, the second connecting portion 122 is obstructed by a contour of a communication window between the rotating cavity 134 and the avoidance notch 131.

On the basis of the foregoing embodiment, at least two ends of the first connecting portion 123 are hollow and form axial ports. At least two axial ends of the first connecting portion 123 each are provided with the gap 121. Gaps in the two axial ends of the first connecting portion 123 respectively extend to the edges of the two axial ends of the first connecting portion 123. It is to be understood that in other embodiments, the gap 121 may also be formed in one end of the first connecting portion 123, or alternatively, the gap 121 in the end of the first connecting portion 123 does not extend axially, but may extend circumferentially. When the gap 121 in the end of the first connecting portion 123 extends circumferentially, a continuous squeezing force axially applied to the first connecting portion 123 is to be ensured. It is to be noted that the circumferentially extending gap 121 is adapted to all embodiments.

As shown in FIGS. 5 and 6, the light-emitting assembly 110 includes radiator 130 and light-emitting member 140. The radiator 130 is provided with the rotating cavity 134. The light-emitting member 140 is disposed on the radiator 130. Through contact between the light-emitting member 140 and the radiator 130, the operating heat is effectively conducted to the radiator 130, thereby protecting the light-emitting member 140 from being damaged due to a high temperature. Optionally, the radiator 130 is made of an aluminum alloy. Alternatively, the radiator 130 may also be made of other materials with high heat dissipation performance, which is not limited herein.

Optionally, the light-emitting member 140 may be a light-emitting panel. The light-emitting member 140 may include a plurality of light-emitting diode (LED) lamps that are connected in parallel and/or series. The LED lamps that are connected in parallel and/or series jointly form a light-emitting surface of the light-emitting panel.

The rotating cavity 134 is formed inside the radiator 130. The radiator 130 is further provided with the avoidance notch 131. The avoidance notch 131 extends from the rotating cavity 134 to an edge of the radiator 130. The avoidance notch 131 is configured to provide a space through which the second connecting portion 122 movably penetrates into the avoidance notch 131.

As shown in FIGS. 5 and 6, the radiator 130 includes heat dissipation body 132 and heat dissipation cover 133 disposed on the heat dissipation body 132. The heat dissipation cover 133 and the heat dissipation body 132 are arranged in sequence along a thickness direction of the radiator 130. The light-emitting member 140 is disposed on a side of the heat dissipation body 132 facing away from the heat dissipation cover 133. A junction between the heat dissipation body 132 and the heat dissipation cover 133 is provided with the rotating cavity 134. The first connecting portion 123 is press-fitted between the heat dissipation cover 133 and the heat dissipation body 132. Notches are respectively formed in the heat dissipation cover 133 and the heat dissipation body 132, so as to jointly form the avoidance notch 131.

Specifically, the junction between the heat dissipation body 132 and the heat dissipation cover 133 is provided with the rotating cavity 134. The first connecting portion 123 is squeezed into the rotating cavity 134. The first connecting portion 123 is provided with the gap 121, such that the connector 120 deforms when squeezed by the heat dissipation body 132 and the heat dissipation cover 133. Through the deformation space in the gap 121, the size of the connector 120 changes with the pressure. Since the connector 120 deforms under the pressure to generate the elastic force, and applies the elastic force to the heat dissipation body 132 and the heat dissipation cover 133, a frictional force between the connector 120 and the radiator 130 increases during rotation of the radiator 130. This ensures that the radiator 130 neither wobbles due to being too loose nor fails to rotate due to being too tight during rotation, and maintains a balanced rotational resistance at all times. Meanwhile, with the gap 121, the service life of the connector 120 can further be prolonged.

Specifically, a side of the heat dissipation cover 133 facing the heat dissipation body 132 is provided with a first groove. A side of the heat dissipation body 132 facing the heat dissipation cover 133 is provided with a second groove. The first groove and the second groove are joined to form the rotating cavity 134.

Specifically, the light-emitting assembly 110 can rotate about the first connecting portion 123 as a rotation shaft, such that the light-emitting surface of the light-emitting assembly 110 is switched between a horizontally downward or upward state and an obliquely downward or upward state. For example, when the light-emitting surface of the light-emitting assembly 110 is switched from the horizontally downward state to the obliquely downward state, the avoidance notch 131 provides a moving space for the second connecting portion 122, such that the second connecting portion 122 movably penetrates into the avoidance notch 131. When the light-emitting surface of the light-emitting assembly 110 is switched between the horizontally upward state and the obliquely upward state, the principle is the same and is not repeated. Specifically, in this embodiment, the light-emitting surface of the light-emitting assembly 110 is perpendicular to the thickness direction of the radiator 130.

Although the present disclosure has been described with reference to several typical embodiments, it should be understood that the terminology used is illustrative and exemplary rather than restrictive. Since the present disclosure can be implemented in various forms without departing from its spirit or essence, it should be understood that the above-described embodiments are not limited by any foregoing details but should be broadly interpreted within the spirit and scope defined by the appended claims. Therefore, all changes and modifications falling within the scope of the claims or equivalents thereof should be covered by the appended claims.

What is claimed is:

1. A support stand, comprising:
a main body;
a plurality of support legs, wherein a first end of each of the plurality of support legs is rotatably connected to the main body, and the plurality of support legs are allowed to rotate relative to the main body for unfolding and folding; and
a magnetic footpad assembly, wherein a second end of at least one of the plurality of support legs is provided with the magnetic footpad assembly, the magnetic footpad assembly comprises a protective shell and a magnet, the magnet is disposed in the protective shell, and an angle of the magnet relative to the support leg is adjustable.

2. The support stand according to claim 1, wherein the protective shell is rotatably disposed on the second end of the support leg; and the protective shell enables the angle of the magnet relative to the support leg to be adjusted.

3. The support stand according to claim 2, wherein the magnetic footpad assembly further comprises a rotation shaft; the rotation shaft is connected to the protective shell and the second end of the support leg; and the protective shell is allowed to rotate axially about the rotation shaft relative to the support leg.

4. The support stand according to claim 1, wherein the protective shell is a flexible housing; and with flexible deformation, the protective shell enables the angle of the magnet relative to the support leg to be adjusted.

5. The support stand according to claim 1, wherein second ends of all of the plurality of support legs are provided with the magnetic footpad assemblies, respectively.

6. The support stand according to claim 5, wherein there are two support legs; and when the two support legs are in a folded state, magnets disposed on the second ends of the two support legs are allowed to attract each other to maintain the two support legs in the folded state.

7. The support stand according to claim 1, wherein the protective shell encloses a periphery and a top surface of the magnet; a bottom of the protective shell is provided with an avoidance opening; a bottom surface of the magnet is exposed through the avoidance opening; and the bottom surface of the magnet constitutes a magnetic attraction surface of the magnet.

8. The support stand according to claim 1, wherein the protective shell is provided with a first fixing hole; the magnet is provided with a second fixing hole; the magnetic footpad assembly further comprises a fastener; and the fastener passes through the first fixing hole and the second fixing hole in sequence to fixedly connect the protective shell and the magnet.

9. The support stand according to claim 1, wherein the magnet and the protective shell each have a rectangular cross-section; and an outer contour of the magnet matches an inner contour of the protective shell.

10. A lighting device, comprising: a lighting assembly and the support stand according to claim 1, wherein the lighting assembly is disposed on a top end of the main body.
